(19) United States
(12) Patent Application Publication
(10) Pub. No.: US 2020/0129360 A1
(43) Pub. Date: Apr. 30, 2020

(54) APPARATUS FOR ASSISTING PHYSICAL MOVEMENT

(71) Applicant: NEOFECT Co., Ltd., Seongnam-si (KR)

(72) Inventors: Hyeon Jae JU, Asan-si (KR); Young Geun CHOI, Giheung-gu (KR); Min Jae PARK, Gunpo-si (KR)

(73) Assignee: NEOFECT Co., Ltd., Seongnam-si (KR)

(21) Appl. No.: 16/728,875

(22) Filed: Dec. 27, 2019

Related U.S. Application Data
(63) Continuation of application No. PCT/KR2018/007174, filed on Jun. 25, 2018.

(30) Foreign Application Priority Data
Jun. 29, 2017 (KR) 10-2017-0082706
Aug. 31, 2017 (KR) 10-2017-0111093

(51) Int. Cl. A61H 1/02

(52) U.S. Cl. CPC A61H 1/0274; A61H 1/0288; A61H 1/0277; A61H 2201/1676; A61H 2001/0203; A61H 2201/1638; A61H 2201/5061

(57) ABSTRACT

An apparatus for assisting physical movement is provided. The apparatus for assisting physical movement includes a body wearing unit put on a specific body of a user, a strap linked to one side of the body wearing unit, a strain sensor provided on the strap to measure a tension applied to the strap, and a strap driving unit linked to the strap to wind or unwind the strap depending on rotation. The strap driving unit rotates in a stationary state such that a reference tension having a specific intensity is applied to the strain sensor, and rotates in a specific direction as the applied tension to the strap becomes higher or lower the reference tension depending on movement of a user.

### CROSS-REFERENCE TO RELATED APPLICATIONS

The present application is a continuation of International Patent Application No. PCT/KR2018/007174, filed on Jun. 25, 2018 which are based upon and claims the benefit of priority to Korean Patent Application Nos. 10-2017-0082706 filed on Jun. 29, 2017 and 10-2017-0111093 filed on Aug. 31, 2017. The disclosures of the above-listed applications are hereby incorporated by reference herein in their entirety.

### BACKGROUND

Embodiments of the inventive concept relate to an apparatus for assisting physical movement of a patient with disability.

In general, regarding each joint part of a human body, parts adjacent to the joint part has a structure rotatable about the joint part.

Meanwhile, the elderly or rehabilitation patients with weak muscles have difficulties in the joint movement as compared to healthy people, and need to perform rehabilitation exercises, but it is difficult for them to perform the rehabilitation exercises using general fitness equipment.

In particular, in the case of stroke or Parkinson's disease, various physical changes appear depending on conditions. In particular, such a disease is followed by the phenomenon that a hand is paralyzed and fingers are shrunken.

If the phenomenon that the hand is paralyzed and the fingers are shrunken is continuously neglected, muscles or joints are gradually hardened and patients feel pain when moving. Even if nerves of the patients are recovered, the patients have a difficulty in normal activity.

In addition, a patient undergoing the surgery on a joint such as a wrist and a shoulder cannot exercise for herself/himself, so the muscle of the patient is weakened and nutrition is not smoothly supplied. Accordingly, there is a risk that joints of the wrist and shoulder become stiff and hardened.

Accordingly, as the rehabilitation treatment is performed such that the patient steadily exercises a hand having paralysis or disability, it is significantly important to maintain the maximum exercise capacity by promoting the blood circulation and neural communication.

In other words, the rehabilitation exercise having a patient is required for a long time to prevent a joint from being deformed and to allow the patient to return to perform a normal life.

(Prior Document 1) Korean Patent Publication No. 10-1163903 (the title of the invention: “EXOSKELETON ROBOT FOR UPPER LIMB REHABILITATION OF PATIENT HAVING STROKE”, issued on Jul. 2, 2012.0)

### SUMMARY

Embodiments of the inventive concept provide an apparatus for assisting physical movement, capable of effectively providing rehabilitation training by detecting the intention of body movement of a patient based on the tension on a strap, which is obtained through a strain sensor and appropriately providing power for assisting the body movement.

The objects of the inventive concept are not limited to the above, but other effects, which are not mentioned, will be apparently understood to those skilled in the art.

According to an exemplary embodiment of the inventive concept, an apparatus for assisting physical movement, includes a body wearing unit put on a specific body of a user, a strap linked to one side of the body wearing unit, a strain sensor provided on the strap to measure a tension applied to the strap, and a strap driving unit linked to the strap to wind or unwind the strap depending on rotation. The strap driving unit rotates in a stationary state such that a reference tension having a specific intensity is applied to the strain sensor, and rotates in a specific direction as the applied tension to the strap becomes higher or lower the reference tension depending on movement of a user.

According to an exemplary embodiment, the apparatus further includes a control unit to control the strap driving unit based on a measurement value of the strain sensor, and the control unit sets the reference tension and a maximum tension.

According to an exemplary embodiment, the control unit rotate the strap driving unit in a direction of winding the strap when the applied tension becomes lower than the reference tension by a threshold value or more, and rotates the strap driving unit in a direction of unwinding the strap when the applied tension becomes greater than the reference tension by a threshold value or more.

According to an exemplary embodiment, the body wearing unit includes a plurality of finger wearing units put on finger joints.

According to an exemplary embodiment, the apparatus includes a plurality of strap driving units which wind or unwind straps linked to finger wearing units, respectively.

According to an exemplary embodiment, the apparatus further includes an encoder to measure rotation data of the strap driving unit, and the rotation data is a revolution per minute (RPM) or a rotational angle.

According to an exemplary embodiment, the apparatus further includes a communication unit to transmit the rotation data to a terminal, and the terminal generates and outputs a body image corresponding to the rotation data.

According to an exemplary embodiment, the apparatus further includes a wrist support unit provided on a wrist portion of a patient to support a wrist of the patient, and an upper limb support unit spaced apart from the wrist support unit to support an upper limb of the patient, when the body wearing unit is a finger wearing unit provided on a hand back of a patient to perform rehabilitation training for a finger of the patient.

According to an exemplary embodiment, the upper limb support unit includes an elbow rest to rest an elbow of the patient, and a lifting unit to operate as the upper limb rested in the elbow rest moves up and down.

According to an exemplary embodiment, the lifting unit may include a first joint link pivotably hinged to the elbow rest, a second joint link pivotably hinged to the first joint link, a pivot joint pivotably hinged to the first joint link and the second joint link, and a pivot moving unit to pivotably move the first joint link, the second joint link, and the pivot joint, as the upper limb rested in the elbow rest moves up and down.

According to an exemplary embodiment, the apparatus includes an encoder to measure rotation data of the strap driving unit, an arrangement state measuring unit to generate arrangement state data by measuring a real-time arrangement state of the wrist support unit and the limb support unit, and a communication unit to transmit the rotation data and the arrangement state data. The terminal generates and outputs a real-time body image based on the rotation data and the arrangement state data.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram illustrating an apparatus for assisting physical movement, according to an embodiment of the inventive concept;

FIG. 2 is a block diagram illustrating an apparatus for assisting physical movement, which further includes an encoder, according to an embodiment of the inventive concept;

FIG. 3 is a block diagram illustrating an apparatus for assisting physical movement, which further includes a communication unit, according to an embodiment of the inventive concept;

FIG. 4 is a perspective view illustrating a front surface of an apparatus for assisting physical movement, which includes a finger wearing unit, a wrist support unit, and an upper limb support unit, according to an embodiment of the inventive concept;

FIG. 5 is a perspective view illustrating a bottom surface of FIG. 4;

FIG. 6 is an enlarged view of a subject matter of a finger exercise unit;

FIG. 7 is a sectional view illustrating a subject matter of FIG. 4;

FIG. 8 is a view illustrating the apparatus for assisting physical movement, which is illustrated in FIG. 4 and has an upper limb;

FIG. 9 is a block diagram illustrating a apparatus for assisting physical movement including an upper limb support unit and a wrist support unit, according to an embodiment of the inventive concept; and

FIGS. 10A-10C are views illustrating the procedure of operating a strain sensor.

### DETAILED DESCRIPTION

Hereinafter, exemplary embodiments of the inventive concept will be described with reference to accompanying drawings. Advantage points and features of the prevent invention and a method of accomplishing thereof will become apparent from the following description with reference to the following figures, wherein embodiments will be described in detail with reference to the accompanying drawings. The present invention, however, may be embodied in various different forms, and should not be construed as being limited only to the illustrated embodiments. Rather, these embodiments are provided as examples so that this disclosure will be thorough and complete, and will fully convey the concept of the present invention to those skilled in the art. The present invention may be defined by scope of the claims. Meanwhile, the terminology used herein to describe embodiments of the invention is not intended to limit the scope of the present invention. Like reference numerals refer to like elements throughout the whole specification.

Unless otherwise defined, all terms (including technical and scientific terms) used herein have the same meaning as commonly understood by those skilled in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terminology used in the inventive concept is provided for the illustrative purpose, but the inventive concept is not limited thereto. As used herein, the singular terms “a,” “an” and “the” are intended to include the plural forms as well, unless the context clearly indicates otherwise. Furthermore, it will be further understood that the terms “comprises”, “comprising,” “includes” and/or “including”, when used herein, specify the presence of stated elements, steps, operations, and/or devices, but do not preclude the presence or addition of one or more other components, steps, operations and/or devices.

Herein, an ‘applied tension’ refers to a tension obtained by a strain sensor at every measurement time point.

Herein, a ‘reference tension’ refers to a tension set as a reference for comparison with the applied tension to determine the movement direction of a user body.

Herein, a ‘minimum tension’ refers to a tension set to be applied at least to the strap or strain sensor.

Herein, the ‘maximum tension’ refers to the maximum tension allowed to be applied to the strap or the strain sensor.

Hereinafter, an apparatus for assisting physical movement will be described in detail according to an embodiment of the inventive concept.

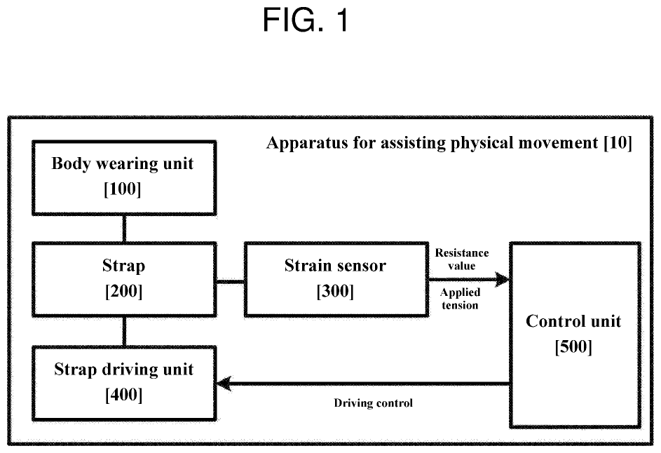

FIG. 1 is a block diagram illustrating an apparatus for assisting physical movement, according to an embodiment of the inventive concept.

Referring to FIG. 1, according to an embodiment of the inventive concept, an apparatus for assisting physical movement includes all or some of a body wearing unit 100, a strap 200, a strain sensor 300, a control unit 500, and a strap driving unit 400.

The body wearing unit 100 is put on a specific body part of a user. The body wearing unit 100 is put on a body part to be assisted by the apparatus 10 for assisting physical movement and to be moved. For example, when the user performs rehabilitation training for a finger of the user, the body wearing unit 100 may be a finger wearing unit. In other words, the body wearing unit 100 is put on a body part having a joint placed between the body part and a body part for placing the strap driving unit 400.

The strap 200 is connected to one side of the body wearing unit 100. One end portion of the strap 200 is coupled to the body wearing unit 100, and an opposite end portion of the strap 200 is coupled to the strap driving unit 400 to be described later.

According to an embodiment, the strap 200 includes a material elastically deformed in a length direction depending on bending (that is, the bending of a joint interposed between the body wearing unit 100 and the strap driving unit 400) of the body part having the body wearing unit 100. In this case, preferably, the strap 200 is designed to minimize resistance when a patient having a difficulty in applying force to the finger of the patient bends the finger,

The strap 200 may have a band shape of a specific width such that the strain sensor 300 to be described later is disposed thereon.

The strain sensor 300 is disposed on the strap 200 to measure the tension applied to the strap 200. The strain sensor 300 may be printed or attached onto one flat surface of the strap 200. In other words, the strain sensor 300 may be provided onto the one flat surface of the strap 200 to measure force applied to the strap 200 as the strap 200 is elastically deformed.

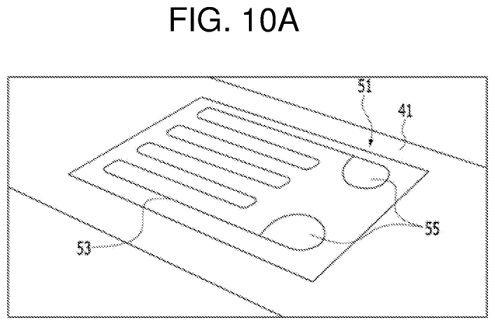

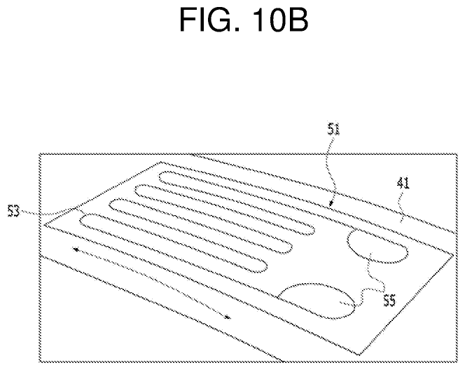

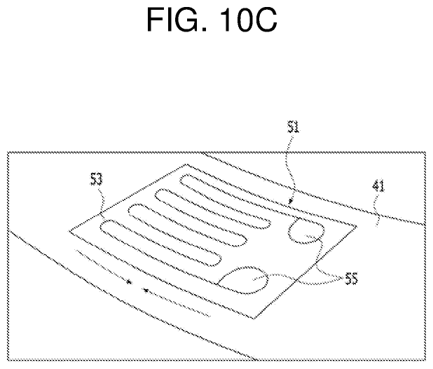

Hereinafter, a strain sensor 51 (or strap sensor 300) will be described in more detail with reference to FIGS. 10A to 10C. The strain sensor 51 (or strap sensor 300) include a metal pattern 53 constituting a circuit, and a terminal 55 electrically connected with the metal pattern 53. The strain sensor 51 (or strap sensor 300) may be printed or attached onto one flat surface of the straps 200 and 41.

Accordingly, the strain sensor 51 (or strap sensor 300) measures force applied to a strap 41 (or strap 200) by measuring resistance applied to the metal pattern 53 depending on the extent of the elastic deformation of the strain sensor 51 (or strain sensor 300), for example, the extent that the strap 41 (or strap 200) is stretched or shrunken in a lengthwise direction.

For example, as the strap 41 (or strap 200) receives tension to be stretched as illustrated in FIG. 10B, in the state that the strain sensor 51 (or the strain sensor 300) is in a normal state as illustrated in FIG. 10A, the length of the metal pattern 53 of the strain sensor 51 (or strain sensor 300) increases, so the resistance value of the metal pattern 53 increases. To the contrary, when the strap 41 (or strap 200) is compressed to be shrunken as illustrated in FIG. 10C, the length of the metal pattern 53 of the strain sensor 51 (or strain sensor 300) decreases, so the resistance value of the metal pattern 53 decreases. In addition, the driving of the strap driving unit 400 is controlled based on the resistance value measured by the strain sensor 51 (or strain sensor 300).

The strap driving unit 400 is linked to the strap 200. As the strap driving unit 400 rotates, the strap driving unit 400 winds or unwinds the strap 200. The strap driving unit 400 rotates in a stationary state such that a reference tension having a specific intensity is applied to the strain sensor 300. The strap driving unit 400 rotates in a specific direction as the tension applied to the strap 200 becomes higher or lower than the reference tension depending on the movement of a user.

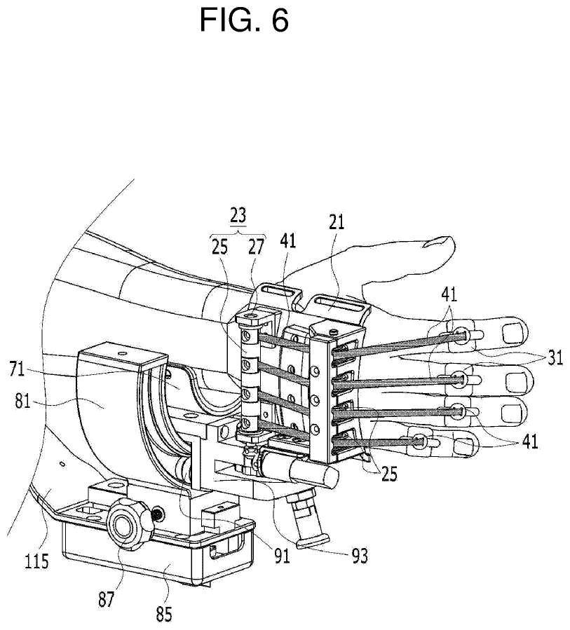

According to an embodiment, as illustrated in FIG. 6, the strap driving unit 400 includes a strap winding roller 25, which is placed horizontally to a movement direction of the strap 200 to wind or unwind the strap 200 (or strap 41), and a strap driving motor 27 to reversibly rotate the strap winding roller 25. Accordingly, as the strap driving motor 27 reversibly rotates, the strap 200 (or strap 41) is wound around or unwound from the strap winding roller 25.

The control unit 500 controls the strap driving unit 400 based on a measurement value (that is, resistance value) of the strain sensor 300. The control unit 500 controls the rotational direction of the strap driving unit 400 (for example, the rotation motor) by comparing the reference tension with the real-time applied tension as the control unit 500 sets the reference tension. In other words, the control unit 500 rotates the strap driving unit 400 in a direction of winding the strap 200, when the applied tension becomes less than the reference tension by a threshold value or more, and rotates the strap driving unit 400 in a direction unwinding the strap 200, when the applied tension becomes greater than the reference tension by a threshold value or more. When the difference between the applied tension, which is calculated based on the resistance value of the strain sensor 300, and the reference tension is less than the threshold value, the control unit 500 determines that the body part is in the stationary state without movement, so the control unit 500 does not drive the strap driving unit 400.

To this end, when the body part having the body wearing unit 100 is in a stationary state, the control unit 500 controls the strap driving unit 400 to apply the reference tension to the strap 200. According to an embodiment, the reference tension may be fixed to the minimum tension. In other words, the control unit 500 may repeatedly drive the strap driving unit 400 to apply the minimum tension to the strap when the user moves the body part. In addition, according to another embodiment, the reference tension may be set to a value equal to or greater than the minimum tension or periodically changed. For example, when the movement of the body part of the user is in the stationary state, the reference tension is set to the minimum tension. When the user body moves, the reference tension may be changed and set based on the applied tension. When the reference tension is periodically updated such that the reference tension is matched to the applied tension, the control unit 500 may determine the movement direction of the user body without continuously driving the strap driving unit 400. When the changed reference tension approaches the maximum tension, the control unit 500 drives the strap driving unit 400 to reduce the applied tension of the strap and updates the reference tension such that the reference tension is matched to the applied tension.

The control unit 500 determines the movement direction or the movement type (for example, bending or spreading) of the body part by comparing the reference tension with the applied tension. Accordingly, when the strap driving unit 400 stops after assisting the movement of the body part to be matched to the movement of the body part, the control unit 500 rotates and stops the strap driving unit 400 such that the resistance value corresponding to the reference tension is measured by the strain sensor 300. In other words, the control unit 500 controls the strap driving unit 400 to form a reference state in that the reference tension is applied to the strain sensor 300, such that the next movement direction of the body part is determined when the body part is stopped.

According to another embodiment, the control unit 500 sets the maximum tension. In other words, the control unit 500 may stop the strap driving unit 400 or adjust the rotation speed of the strap driving unit 400, when the applied tension measured by the strain sensor 300 is within a specific range from the maximum tension. When the body part of the patient is pulled with excessive tension, the body may be overwhelmed, so that the control unit 500 performs a control operation to prevent the maximum tension of from being applied in the exercise of the body part.

For example, when the patient spreads the body part (for example, a bent finger), and when the control unit 500 determines the bent joint as being spread due to the applied pressure equal to or lower than the reference tension and controls the strap driving unit 400 to rotate the strap 200 in a winding direction, the moving speed of the body part becomes lower than the rotation speed of a motor, so the tension applied to the strap 200 may be increased to be almost the maximum tension. In this case, if the strap driving unit 400 rotates at a speed higher than the movement speed of the body part to pull the body part, force may be excessively applied to the body part. Accordingly, the control unit 500 may stop the motor rotation or reduce the rotation speed of the motor when the applied tension approaches the maximum tension.

In addition, for example, as the muscles of the body part of the patient are hardened, the bent posture may be a normal posture. Accordingly, the body part may be rapidly bent again as the patient loses the strength of the muscles of the body part after spreading the bent body part. When the bending speed of the body part is higher than the speed in which the strap driving unit 400 unwinds the strap 200, the applied tension applied to the strap 200 may be gradually increased. When the applied tension approaches the maximum tension, the control unit 500 may increase the rotation speed of the strap driving unit 400 to rapidly unwind the strap 200, such that the applied tension is lowered.

Accordingly, as suitable power is applied to a body part having a difficulty in performing normal joint movement, rehabilitation training suitable for the state of the patient may be provided.

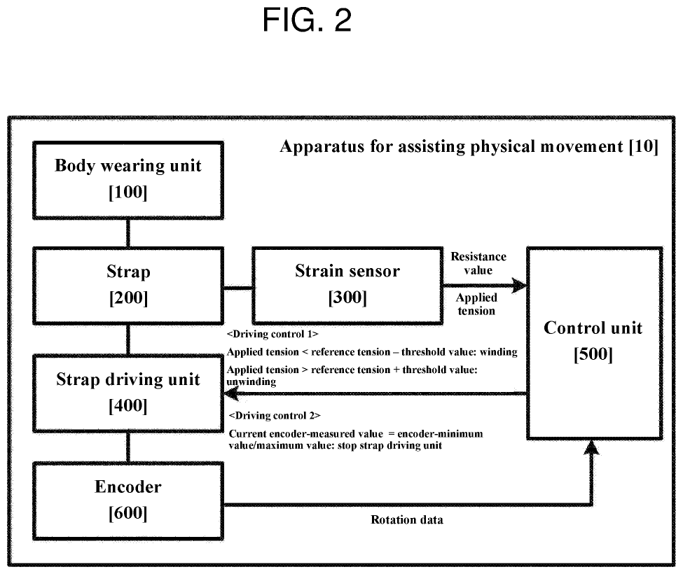

In addition, according another embodiment, as illustrated in FIG. 2, an encoder 600 is further provided. The encoder 600 measures rotation data of the strap driving unit 400. The rotation data is a rotation speed or rotation angle. The rotation data may be used to calculate the extent to which the strap 200 is wound.

For example, when storing the entire length of the strap 200 and the circumferential length of the strap winding roller, and when the length of the strap 200 wound around the strap winding roller is calculated based on the revolution per minute (RPM) or the rotational angle obtained by the encoder 600, the present length of the strap 200 between the body part and the strap driving unit 400 may be detected. The current length of the strap 200 between the body wearing unit 100 and the strap driving unit 400 may be used to calculate the present state of the body part.

In addition, according to another embodiment, the control unit 500 may store the maximum value and the minimum value of the encoder 600. In other words, the control unit 500 sets the value of the encoder 600 to the minimum value when the body part is bent to the maximum extent, and sets the value of the encoder 600 to the maximum value when the body part is fully spread. Accordingly, the control unit 500 stops the rotation of the strap driving unit 400 when the measurement value of the encoder 600 reaches the maximum value or the minimum value, to prevent the strap driving unit 400 from assisting the body part beyond the movable rage of the body part. The control unit 500 may initially set the maximum value and minimum value of the measurement value of the encoder 600 by spreading and bending the body parts when the patient starts the rehabilitation training. Since the patient may not be able to exercise the joint as much as the maximum movable range, the maximum value and the minimum value of the measurement value of the encoder 600 may be initially set by allowing the patient to exercise a joint from the maximum bending state to the maximum spread state in initial setting.

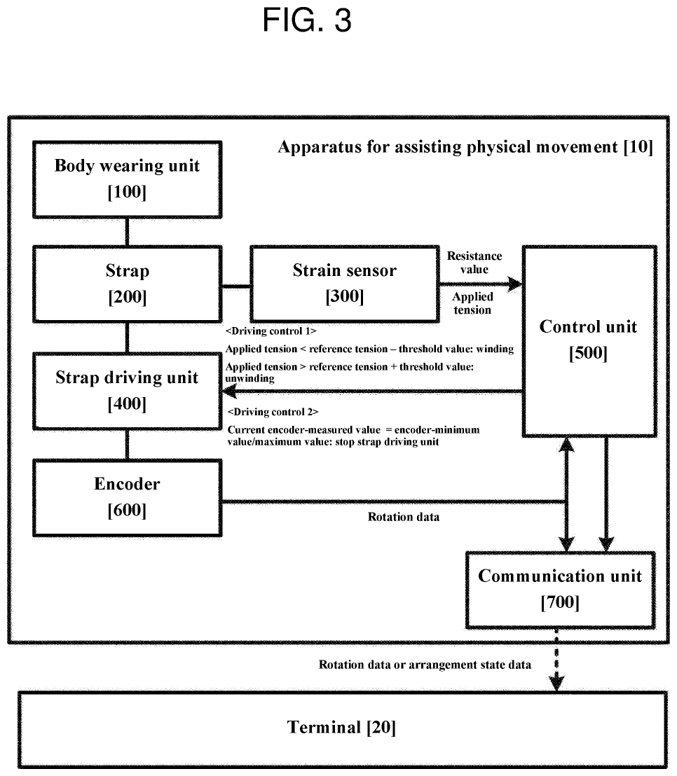

In addition, according to another embodiment, as illustrated in FIG. 3, a communication unit 700 may be further included. For example, the communication unit 700 transmits rotation data, which is obtained from the encoder 600, to the terminal 20. In other words, after receiving the rotation data from the apparatus 10 for assisting physical movement, the terminal 20 calculates the present length of the strap 200 between the body wearing unit 100 and the strap driving unit 400 by applying the rotation data to the entire length of the strap 200 and the circumferential length of the strap 200, and measures the arrangement state (for example, the bending angle of the body part) of the body part based on the present length of the strap 200 between the body wearing unit 100 and the strap driving unit 400. Thereafter, the terminal 20 generates and outputs a body image corresponding to the present arrangement state of the body part.

In addition, for example, the communication unit 700 transmits, to the terminal 20, the present arrangement state data of the body part calculated by the control unit 500 based on the rotation data obtained from the encoder 600. In other words, the encoder 600 transmits the rotation data to the control unit 500, and the control unit 500 calculates the present length of the strap 200 between the body wearing unit 100 and the strap driving unit 400 by applying the rotation data to the entire length of the strap 200 and the circumferential length of the strap 200, and measures the present arrangement state of the body part based on the present length of the strap 200 between the body wearing unit 100 and the strap driving unit 400. Thereafter, the control unit 500 transmits the arrangement state data to the communication unit 700, and the communication unit 700 transmits the arrangement state data to the terminal 20 through wired or wireless communication. Thereafter, the terminal 20 generates and output a body image corresponding to the present arrangement state of the body part.

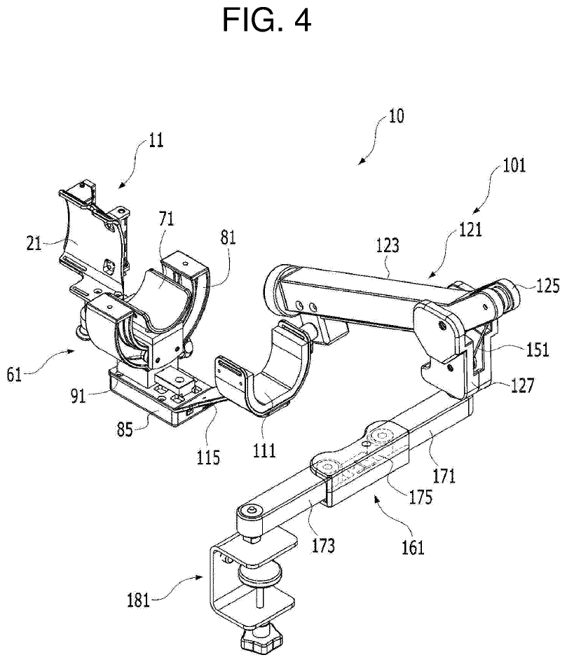

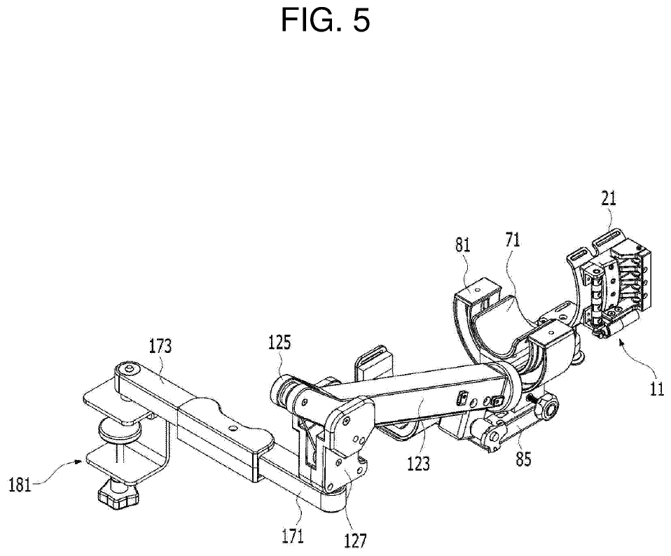

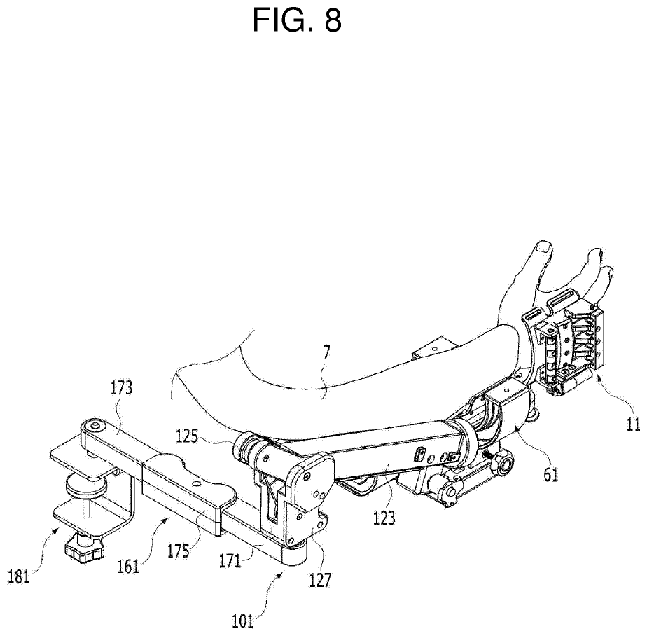

According to another embodiment, the body wearing unit 100 is a plurality of finger wearing units put on finger joints. Hereinafter, a case in which the body wearing unit pulled by the strap driving unit 400 is a finger wearing unit will be described in detail with reference to FIGS. 4 to 8.

The finger wearing unit 31 includes a silicon material, has the shape of a ring, and is coupled to each finger of the patient. Meanwhile, although the present embodiment has been described in that the finger wearing unit 31 is provided to correspond to, but is not limited thereto, each of an index finger, a middle finger, a ring finger, and a pinky finger.

In addition, the apparatus 10 for assisting physical movement may further include a hand back wearing unit 21 having a strap driving unit 23. The hand back wearing unit 21 includes the strap driving unit 23 to wind or unwind a strap 41.

In addition, the hand back wearing unit 21 includes a plurality of strap guide rollers 25 provided on the movement path of the strap 41 moving along a top surface of the hand back wearing unit 21, to guide the movement of the strap 41. The strap guide rollers 25 are provided corresponding to the number of straps 41, and spaced apart from each other by a specific distance. The strap 41 has the shape of a band having a specific width, and the hand back wearing unit 21 has a movement path including the strap 41.

As described above, the hand back wearing unit 21 is provided on the back of the patient's hand, and the finger wearing unit 31 is coupled to each finger which is bent. In this state, as the strap driving unit 23 is driven to wind or unwind the strap 41, the patient may perform the rehabilitation training by exercising the finger of the patient.

In addition, according to another embodiment, a plurality of strap driving units wind or unwind straps linked to finger wearing units, respectively. In other words, according to an embodiment, the apparatus for assisting physical movement may further include a plurality of strap driving units to individually assist an exercise suitable for each finger connected with the strap. The control unit individually controls the strap driving unit connected with each strap, based on the applied tension measured by the strain sensor on each strap

According to an embodiment, when the body wearing unit is a finger wearing unit provided on the hand back of the patient to perform the rehabilitation training for the finger of the patient, a wrist support unit 61 and an upper limb support unit 101 are further provided.

The wrist support unit 61 is provided on the wrist portion of the patient to support the wrist of the patient. The wrist support unit 61 includes a wrist rest 71 on which a wrist is rested, and a track 81 provided along the rotation trajectory of the wrist to guide the rotational movement of the wrist rest 71.

The wrist rest 71 has a circular sectional shape, for example, a sectional shape of ‘U’ having an open upper portion to partially surround the wrist. Accordingly, the patient may stably rest the wrist to the wrist rest 71. In this case, a band is provided on the wrist rest 71 to fix the wrist such that the wrist is prevented from deviating from the wrist rest 71.

A track 81 has a sectional shape of ‘U’ corresponding to the shape of the wrist rest 71. The track 81 is supported by a support 85. The support 85 includes a gap adjusting knob 87 to adjust a gap between the wrist rest 71 and an elbow rest 111 of the upper limb support unit 101 to be described later

Meanwhile, the track 81 includes a roller 91 corresponding to the rotational movement of the wrist rest 71 about the track 81. The roller 91 is provided to be movable while rolling the track 81, and linked to the wrist rest 71 by a roller support bracket 93.

Accordingly, the wrist rest 71 moves along the track 81 by rotational force applied to the wrist of the patient.

As described above, when rotational force is applied to the wrist after the wrist is rested in the wrist rest 71, the wrist rest 71 moves along the track 81 such that the wrist smoothly rotates.

The upper limb support unit 101 is disposed to be spaced apart from the wrist support unit, to support the upper limb of the patient. According to one embodiment, the upper limb support unit 101 includes an elbow rest 111 to rest an elbow of the patient and a lifting unit 121 to operate as the upper limb rested in the elbow rest 111 moves up and down.

The elbow rest 111 has a sectional shape of ‘U’ having an open upper portion to partially surround the elbow. Accordingly, the patient may stably rest the elbow to the elbow rest 111. In this case, a band is provided on the elbow rest 111 to fix the elbow such that the elbow is prevented from deviating from the elbow rest 111.

Meanwhile, the elbow rest 111 is connected to a support 85 of the wrist support unit 61 by a connection bracket 115.

The lifting unit 121 includes a pivot moving unit to pivot a pair of joint links 123 and 125 and a pivot joint 127 as a pair of joint links 123 and 125, a pivot joint 127, and the upper limb 7 rested on the elbow rest 111.

The pivot moving unit includes a spring 133, a first wire pulley 141, a second wire pulley 143, a third wire pulley 145, a fourth wire pulley 147, and a wire 151.

Meanwhile, a pair of joint links include a first joint link 123 having one end portion coupled to the elbow rest 111 and a second joint link 125 coupled to an opposite end of the first joint link 123.

The first joint link 123 has a hollowed bar shape. One end portion of the first joint link 123 is pivotally hinged to the elbow rest 111, and the opposite end portion of the first joint link 123 is pivotally hinged to one end portion of the second joint link 125 and the pivot joint 127.

Meanwhile, a spring 133 is received in the first joint link 123 to be compressed or extended. One end portion of the spring 133 is supported by the first joint link 123, and an opposite end portion of the spring 133 is linked to the wire 151. In this case, the first joint link 123 is not directly connected with the wire 151, and a connection block (not illustrated) is interposed between the first joint link 123 and the wire 151 such that the first joint link 123 is connected with the wire 151 through the connection block.

One end portion of the second joint link 125 is hinged to tan opposite end portion of the first joint link 123 and the pivot joint 127.

Meanwhile, a plurality of wire pulleys are provided on the movement path of the wire 151.

The plurality of wire pulleys include a first wire pulley 141 provided inside the first joint link 123 while being spaced apart a spring 133 by a specific distance, a second wire pulley 143 provided at a part where the first joint link 123 is hinged with one end portion of the second join link 125, a third wire pulley 145 provided at the pivot joint 127, and a fourth wire pulley 147 provided at an opposite end portion of the second joint link 125.

Accordingly, the wire 151 has a specific length. The wire 151 is supported by the fourth wire pulley 147 through the first wire pulley 141, the second wire pulley 143, and the third wire pulley 145, while extending from an opposite end of the spring 133.

The pivot joint 127 pivotally supports an opposite end portion of the first joint link 123 and one end portion of the second joint link 125.

The third wire pulley 145 is provided at a lower portion of the pivot joint 127 to be exposed.

Accordingly, when the elbow of the patient is rested in the elbow rest 111, as the spring 133 is extended as illustrated in FIG. 4, the length of the wire between the third wire pulley 145 and the fourth wire pulley 147 is increased. In this case, the weight load generated as the elbow of the patient is rested in the elbow rest 11 is compensated by the elastic force of the spring 133.

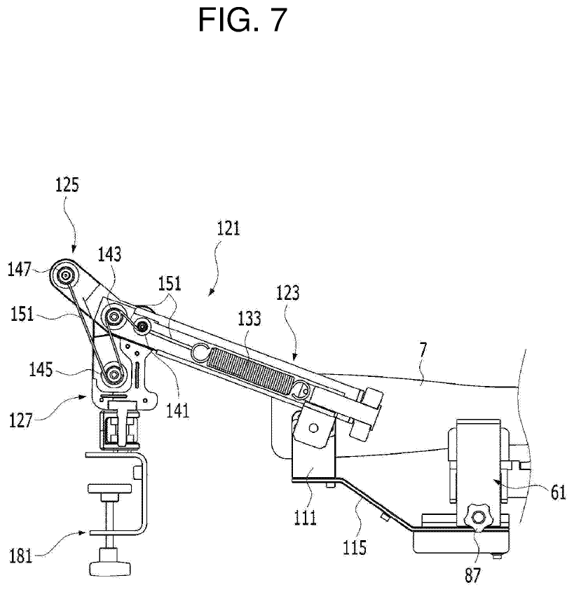

Meanwhile, when the upper limb 7 is lifted up, the second joint link 125 is rotated counterclockwise while the spring 133 is compressed as illustrated in FIG. 7, and the length of the wire 151 between the third wire pulley 145 and the fourth wire is reduced.

Accordingly, when the upper limb 7 is lifted up, the rehabilitation training for the upper limb 7 may be performed without force applied to the upper limb 7.

In addition, according to an embodiment of the inventive concept, the upper limb support unit 101 may further include a left-right operating unit 161 operating as the upper limb 7 moves left and right.

The left-right operating unit 161 includes a pair of upper limbs 171 and 173 provided to be accessible each other and spaced apart from each other.

Each end portion of the pair of arms 171 and 173, that is, each of end portions, which are opposite to each other, of the pair of arms 171 and 173 is pivotably hinged to the bracket 175 to correspond to the left and right movement of the upper limb 7.

The opposite end portion of the arm 171, which is disposed adjacent to the pivot joint 127, of the pair of arms is hinged to the pivot joint 127, and the opposite end portion of the remaining arm 173 is hinged to a fixed member 181 to elastically support the apparatus 10 for assisting physical movement to a structure according to an embodiment of the inventive concept.

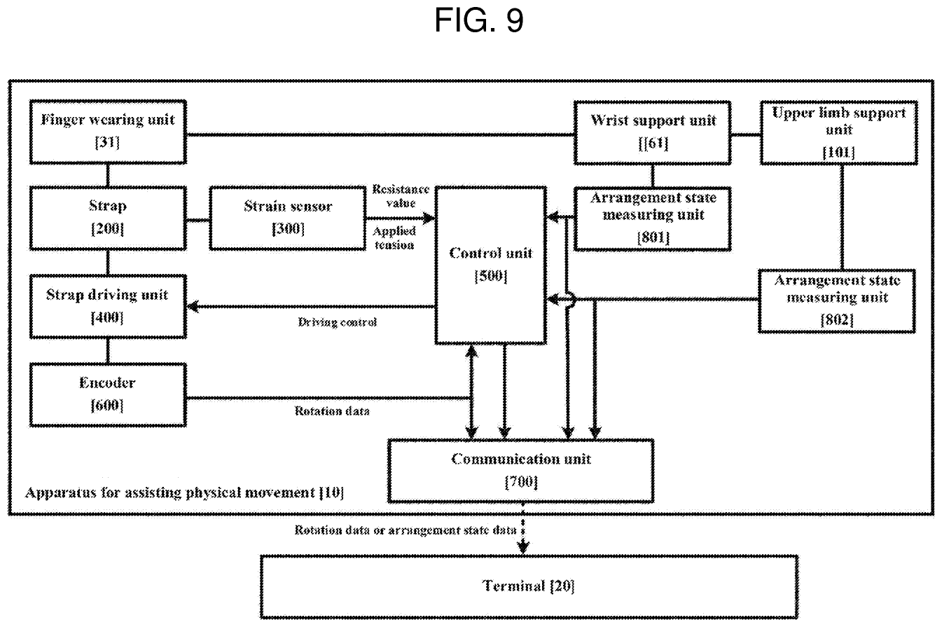

In addition, according to another embodiment, as illustrated in FIG. 9, when the apparatus 10 for assisting physical movement includes a wrist support unit and an upper support unit, the encoder 600 further includes an arrangement state measuring unit 801 and a communication unit 700.

The encoder 600 performs a role of measuring rotation data of the strap driving unit. Hereinafter, the details of the encoder 600 will be omitted.

The arrangement state measuring unit 801 generates the arrangement state data by measuring the real-time arrangement state of the wrist support unit and the upper limb support unit. The real-time arrangement state may be measured through a sensor provided in the wrist support unit and the upper limb support unit.

For example, the arrangement state measuring unit 801 disposed on the wrist support unit may measure the rotation of the roller 91 on the U-shaped track 81 to measure the movement distance from one end portion of the track and to measure the present arrangement state. In addition, for example, the arrangement state measuring unit 801 disposed at the upper limb support unit may calculate the present height of the upper limb unit based on the intensity of the tension applied to a spring 133. However, the manner that the arrangement state measuring unit 801 disposed on the wrist support unit and the upper limb support unit measures the real-time arrangement state is not limited thereto, but includes various manners.

The communication unit 700 transmits, to the terminal 20, the rotation data or a finger arrangement state data obtained in the encoder 600, and the arrangement state data measured by the arrangement state measuring unit 801 disposed on the wrist support unit and the upper limb support unit. The terminal 20 generates and outputs a real-time body part image based on the received data. Accordingly, the user may perform the rehabilitation training while viewing an image representing the present operation of the patient, on a screen of the terminal 20.

As described above, according to the inventive concept, assist power appropriate to the exercise direction of a patient may be provided by detecting the physical movement of the patient through the comparison between the reference tension and the applied tension, thereby effectively providing the physical rehabilitation training.

While the inventive concept has been described with reference to exemplary embodiments, it will be apparent to those skilled in the art that various changes and modifications may be made without departing from the spirit and scope of the inventive concept. Therefore, it should be understood that the above embodiments are not limiting, but illustrative.

What is claimed is:

1. An apparatus for assisting physical movement, the apparatus comprising:
a body wearing unit put on a specific body of a user;
a strap linked to one side of the body wearing unit;
a strain sensor provided on the strap to measure a tension applied to the strap; and
a strap driving unit linked to the strap to wind or unwind the strap depending on rotation,
wherein the strap driving unit:
rotates in a stationary state such that a reference tension having a specific intensity is applied to the strain sensor; and
rotates in a specific direction as the applied tension to the strap becomes higher or lower the reference tension depending on movement of a user.

2. The apparatus of claim 1, further comprising:
a control unit configured to control the strap driving unit based on a measurement value of the strain sensor,
wherein the control unit sets the reference tension and a maximum tension.

3. The apparatus of claim 2, wherein the control unit is configured to:
rotate the strap driving unit in a direction of winding the strap when the applied tension becomes lower than the reference tension by a threshold value or more; and
rotate the strap driving unit in a direction of unwinding the strap when the applied tension becomes greater than the reference tension by a threshold value or more.

4. The apparatus of claim 1, wherein the body wearing unit includes:
a plurality of finger wearing units put on finger joints.

5. The apparatus of claim 4, further comprising:
a plurality of strap driving units which wind or unwind straps linked to finger wearing units, respectively.

6. The apparatus of claim 1, further comprising:
an encoder to measure rotation data of the strap driving unit,
wherein the rotation data is a revolution per minute (RPM) or a rotational angle.

7. The apparatus of claim 6, further comprising:
a communication unit to transmit the rotation data to a terminal,
wherein the terminal generates and outputs a body image corresponding to the rotation data.

8. The apparatus of claim 1, further comprising:
a wrist support unit provided on a wrist portion of a patient to support a wrist of the patient; and
an upper limb support unit spaced apart from the wrist support unit to support an upper limb of the patient,
when the body wearing unit is a finger wearing unit provided on a hand back of a patient to perform rehabilitation training for a finger of the patient.

9. The apparatus of claim 8, wherein the upper limb support unit includes:
an elbow rest to rest an elbow of the patient; and
a lifting unit to operate as the upper limb rested in the elbow rest moves up and down.

10. The apparatus of claim 9, wherein the lifting unit includes:
a first joint link pivotably hinged to the elbow rest;
a second joint link pivotably hinged to the first joint link;
a pivot joint pivotably hinged to the first joint link and the second joint link; and
a pivot moving unit to pivotably move the first joint link, the second joint link, and the pivot joint, as the upper limb rested in the elbow rest moves up and down.

11. The apparatus of claim 8, further comprising:
an encoder to measure rotation data of the strap driving unit;
an arrangement state measuring unit to generate arrangement state data by measuring a real-time arrangement state of the wrist support unit and the limb support unit; and
a communication unit to transmit the rotation data and the arrangement state data,
wherein the terminal generates and outputs a real-time body image based on the rotation data and the arrangement state data.
